(19) United States
(12) Patent Application Publication
(10) Pub. No.: US 2009/0112516 A1
(43) Pub. Date: Apr. 30, 2009

(54) SYSTEM AND METHOD FOR RELATING INFORMATION ACROSS SEEMINGLY UNRELATED TOPICS

(76) Inventors: Ran Zilca, Briarcliff Manor, NY (US); Peter Jason Rentfrow, Cambridge (GB); Anthony Passera, South Nyack, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/877,892

(22) Filed: Oct. 24, 2007

(51) Int. Cl. G06F 17/18

(52) U.S. Cl. 702/181

(57) ABSTRACT

A system and method for determining likelihoods of relationships between unrelated variables associated with characteristics of a user includes collecting scores for a plurality of variables and transforming the scores to discrete values. A first property having a discrete value and a second property having a discrete value are selected. How many times more likely the first property is exhibited for people who have the second property as compared to a general probability in an entire population for the first property to be exhibited is represented by computing a ratio of probabilities. The ratio of probabilities is reported.

### BACKGROUND

1. Technical Field

The present invention relates to human computer interfaces, and more particularly to systems and methods for relating information between data sets which are seemingly unrelated.

2. Description of the Related Art

Many computer applications and data collection schemes involve people filling out surveys or profiles related to aspects of their lives. This information is stored typically in a user profile or in a collection of responses. This stored data can be analyzed. The analytical techniques may include creating probability curves or charts. These charts and curves deal mostly with the frequency of a given response and typically report only the number of responses of a certain type. For example, 80% yes and 20% no responses for a given question.

This information while useful may not be all of the information available to a collector of data. Therefore, a need exists for deriving additional information from surveys or information gathered from individuals.

### SUMMARY

A system and method for determining likelihoods of relationships between unrelated variables associated with characteristics of a user includes collecting scores for a plurality of variables and transforming the scores to discrete values. A first property having a discrete value and a second property having a discrete value are selected. How many times more likely the first property is exhibited for people who have the second property as compared to a general probability in an entire population for the first property to be exhibited is represented by computing a ratio of probabilities. The ratio of probabilities is reported.

A computer readable medium comprising a computer readable program for determining likelihoods of relationships between unrelated variables associated with characteristics of a user may be employed.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for determining likelihoods of relationships between unrelated variables associated with characteristics of a user in accordance with one embodiment; and

FIG. 2 is a block diagram showing a network system for determining likelihoods of relationships between unrelated variables associated with characteristics of a user.

### DETAILED DESCRIPTION OF PREFERRED EMBODIMENTS

Present embodiments relate to connecting or tying information across different surveys or seemingly unrelated information. As an example, a survey may determine that music lovers are five times more likely to have a pet. The present embodiments provide a methodology for determining relationships between information in different surveys using probability measures and scores. The present embodiments are applicable to social networking applications but are also useful for advertising, marketing and demographic studies, among other applications.

Embodiments in accordance with present principles may take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the present embodiments can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

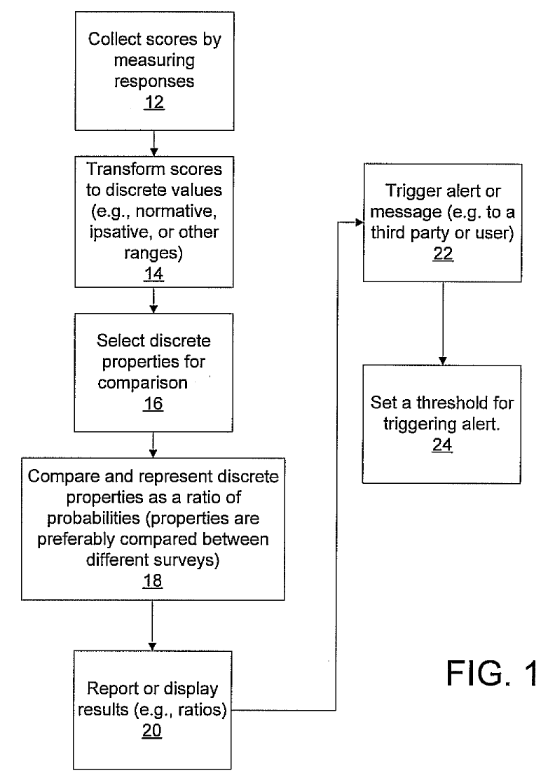

Referring now to the drawings in which like numerals represent the same or similar elements and initially to FIG. 1, a block/flow diagram shows a system/method for relating survey information. A survey is a process that presents different stimuli to a user and measures and/or records the user response. Survey completion results in a set of variables, each of the variables is assigned a number called a “score”. The score represents a weight or magnitude that indicates a relative value for the variable. In one embodiment, the variables include properties such as a personality trait, a user preference, a rating score, etc. In one illustrative example, if a survey question asked, “How intelligent are you?” and the user could enter their IQ score. The variable would be intelligence and the score would be the IQ value.

The variables may include demographic variables. A demographic variable may be used by an advertising company, for example, as ratios as will be described herein would effectively provide information about the probability that, e.g., males, as compared to females, are X times more (or less) likely to do/prefer “Y”.

In block 12, survey scores are collected for each variable. This may be performed using a questionnaire, survey, test or other data collection tool for collecting individual responses to stimuli. The input from the user may be other than a traditional “survey” or “test”, for example, the input may include product or music ratings on a website or any user response to stimuli in general.

In block 14, scores are transformed to discrete values or placed in buckets (ranges). For example, the discreet values may include, low, medium and high where each discrete value represents a range of scores for a given variable. By discretizing these values relationships between scores obtained for different questions may more easily be determined.

There are many ways to transform a generally continuous score obtained from a survey into discrete values. A few examples include: Normatively: using a reference set of scores from other users, e.g., calculate the distribution of the reference set of scores in the entire population and divide to values based on percentiles; ipsatively: using only the user data, e.g., sort all scores (of different variables) for the same user, e.g., ranking the scores by deviation from the middle of the response scale and applying at least two thresholds on this score distribution to produce at least High, Med, and Low discrete values. For example, if the user response scale is 1-9, then the middle of the scale is 5, or 1-3 is low, 4-6 is medium and 7-9 is high.

In another example, converting a continuous score into discrete data includes substituting each score S by its deviation from the center of a scale, S1 (so if it is a 1-9 scale, deviation from 5 is used: “S1=S−5”). Then, substituting the deviation score, S1, by its rank after sorting all trait scores. For example, the trait score S1 that has the highest deviation score will be replaced by “1”, the trait score S1 of the trait that ranked second in deviation score will be substituted by “2”, etc.

In block 16, discrete properties (traits, preferences or information) to be compared are selected and information is compiled. The first property preferably has a particular discrete value and the second property preferably has a discrete value. In this way, particular relationships can be determined between the discrete values.

For example, if a relationship between assertiveness and a preference for rock music is sought, data in one or more populations is obtained for the assertiveness trait (discrete value=high) and data in one or more populations is obtained for a rock music preference (discrete value=preferred or high) to determine relationships. The information may already be collected as part of a prior survey or may be collected in a present survey to determine the relationship.

In block 18, discrete properties (traits, preferences or information) are compared and represented as a ratio to relationship information. E.g., if A is a discrete trait for a variable in a first survey, e.g., A={Assertiveness=High}, and B is a discrete trait in a second survey, e.g., B={RockMusic=High}. Then, the following ratio is calculated: R=P(A|B)/P(A) where P(A) is the general/prior probability of trait A in the entire population, and P(A|B) (probability of A given B) is the probability of trait A in the sub-population where B also occurs. This means that R represents how many times more likely A is exhibited for people who have property B compared to the general probability in the entire population for A to be exhibited. R is referred to as the mutual information between A and B since: R=P(A|B)/P(A)=P(B|A)/P(B). In other words, R also represents how many times more likely B is exhibited for people who have property A compared to the general probability in the entire population for B to be exhibited.

R can also be expressed as R=P(A,B)/(P(A)*P(B)): the probability of both A and B exhibited in a person divided by the product of the individual probabilities of both traits being exhibited. If A and B are statistically independent then P(A,B)=P(A)*P(B), and therefore R=1, then R is also a measure of statistical dependency.

In the example above, if R=4, it means that: People who are highly assertive are 4 times more likely to like Rock music, and people who like Rock music are 4 times more likely to be assertive.

The ratio R can be replaced by other statistical measures, many of which exist. For example: R′=P(A|B)/P(Anot|B) where Anot is the complementary event of A (users who do NOT exhibit trait A). R′ is not mutual, so if R″=P(A|B)/P(Anot|B) then P(A|B)/P(Anot|B)≠P(B|A)/P(Bnot|A) and R″≠R. Other relationships may also be determined.

In block 20, the results are optionally presented or reported. In one embodiment, the relationships between traits are precalculated and entered into program code such that during an activity, such as browsing or completing a survey, this information is displayed as a pop-up or otherwise for the user. For example, during a survey a user answers a question on music preference selecting: “rock music”. A pop-up may display the following remark: “People who like Rock music are 4 times more likely to have an assertive personality.”

In block 22, survey or opinion responses may be employed to trigger an alert or message based on the relationships determined. This may be delivered to a third party such as a business. For example, during a survey, a user answers a question on assertiveness as being in the high range. The user's browser may send a message to a music website alerting them that the user is likely to have an interest in rock music (based upon the above example). Websites may subscribe to such a service and set a threshold as to the likelihood of a preference in block 24. For example, the threshold may be set for likelihoods, e.g., of 3 times or greater. Other thresholds may be employed as well. Therefore, an assertive user may alert a rock music website since people who are highly assertive are 4 times more likely to like Rock music. However, an assertive user may not alert a golf equipment website since people who are highly assertive are only 2 times more likely to play golf.

In another embodiment, in a social computer network application, a user may enter personality or preference data into a system and have a report generated showing not only the most popular answers by the relationships between the answers given by that user and the data collected for this and other surveys. The result would be more than just likely matches to other candidates but give insights to other characteristics or traits that may be of interest.

More examples may include different domains where relationships may be determined between the domains or within the domain. In the personality domain, relationships may be obtained for personality traits or variables (e.g., talkative versus shy). In the vocational interest domain, relationships may be obtained related to financial or career information. Relationships between these may include, for example, people who are highly talkative are far more likely to pursue a career in finance, compared to the general population.

In the non-vocational interest domain (e.g., gardening), relationships may be determined with other domains, such as, music preferences (e.g., distorted complex music with vocals). In one example, a determination can be made such as: people who enjoy gardening in their spare time are 38 times more likely to enjoy distorted and complex music with vocals. Relationships between other domains may be obtained as well, for example, people who enjoy gardening in their spare time are much more likely to be shy compared to the general probability of being shy.

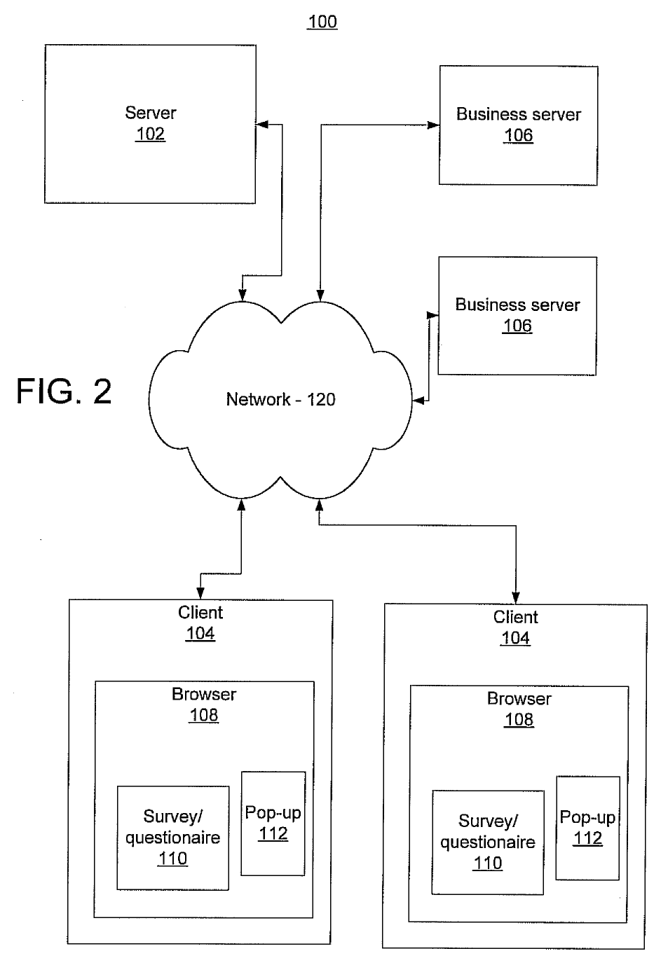

Referring to FIG. 2, an illustrative network system 100 shows one application in accordance with the present principles. System 100 may be implemented over a network 120, such as the the Internet, a cable or satellite network, a local area network, a secured network, etc. System 100 includes at least one server 102 configured to store survey data or other information, compute relationships and optionally report the relationships and likelihoods to clients 104 or business servers 106.

One or more client computers 104 include browsers 108, which provide the needed information and security interfaces for accessing the server 102. In one embodiment, a user logs onto server 102 through browser 108 on a client computer 104. In one application, the user enrolls in a social network and a questionnaire or survey 110 is displayed to obtain information. The information obtained from the user may be employed in a plurality of ways. One way includes collecting the response to create a collection or set of data for assessing a population to discover trends. In addition, the information entered may be simultaneously or independently employed to trigger a pop-up window 112 or other report in accordance with a particular response or set of responses. The pop-up 112 may include related likelihood information from other surveys, stored data or other parts of the user's current survey.

Another way of employing the user's responses includes sending a message to one or more business servers 106 indicating that a given response has been entered by the user and that the response indicates a likelihood that an interest exists in the business servers' 106 goods or services. The business servers 106 may respond with an email, message, advertisements or other promotional or informational materials.

Having described preferred embodiments of a system and method for relating information across seemingly unrelated topics (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for determining likelihoods of relationships between unrelated variables associated with characteristics of a user, comprising:
collecting scores for a plurality of variables;
transforming the scores to discrete values;
selecting a first property having a discrete value and a second property having a discrete value;
representing how many times more likely the first property is exhibited for people who have the second property as compared to a general probability in an entire population for the first property to be exhibited, by computing a ratio of probabilities; and
reporting the ratio of probabilities.

2. The method as recited in claim 1, wherein collecting scores for a plurality of variables includes providing stimuli to a user and recording responses.

3. The method as recited in claim 1, wherein collecting scores for a plurality of variables includes providing one of a survey and a questionnaire and recording responses of a user.

4. The method as recited in claim 1, wherein transforming the scores to discrete values includes assigning a discrete value to each of a plurality of ranges of scores.

5. The method as recited in claim 1, wherein transforming the scores to discrete values includes employing one of a normative approach and an ipsative approach.

6. The method as recited in claim 1, wherein transforming the scores to discrete values includes substituting each score by its deviation from a center of a scale employed to provide the score; and substituting the deviation by a rank of the deviation after sorting all scores to provide the discrete values.

7. The method as recited in claim 1, wherein the first property and second property include one of a personality trait, a user preference, a demographic score and a rating score.

8. The method as recited in claim 1, wherein computing a ratio of probabilities includes computing a ratio R=P(A|B)/P(A) where P(A) is a general probability of the first property in the entire population, and P(A|B) (probability of A given B) is the probability of the first property in a sub-population where the second property also occurs.

9. The method as recited in claim 1, wherein computing a ratio of probabilities includes computing a ratio R′=P(A|B)/P(Anot|B) where P(A|B) (probability of A given B) is the probability of the first property in a sub-population where the second property also occurs and Anot is a complementary event of the first property indicating users who do not exhibit the first property.

10. The method as recited in claim 1, wherein reporting includes displaying the ratio of probabilities for a user.

11. The method as recited in claim 1, wherein reporting includes alerting a third party of the probability ratio.

12. The method as recited in claim 1, wherein the alerting is performed when the ratio of probabilities exceeds a threshold.

13. A computer readable medium comprising a computer readable program for determining likelihoods of relationships between unrelated variables associated with characteristics of a user, wherein the computer readable program when executed on a computer causes the computer to perform to steps of:
collecting scores for a plurality of variables;
transforming the scores to discrete values;
selecting a first property having a discrete value and a second property having a discrete value;
representing how many times more likely the first property is exhibited for people who have the second property as compared to a general probability in an entire population for the first property to be exhibited, by computing a ratio of probabilities; and
reporting the ratio of probabilities,

14. The computer readable medium as recited in claim 13, wherein collecting scores for a plurality of variables includes providing stimuli to a user and recording responses.

15. The computer readable medium as recited in claim 13, wherein collecting scores for a plurality of variables includes providing one of a survey and a questionnaire and recording responses of a user.

16. The computer readable medium as recited in claim 13, wherein transforming the scores to discrete values includes assigning a discrete value to each of a plurality of ranges of scores.

17. The computer readable medium as recited in claim 13, wherein transforming the scores to discrete values includes employing one of a normative approach and an ipsative approach.

18. The computer readable medium as recited in claim 13, wherein transforming the scores to discrete values includes substituting each score by its deviation from a center of a scale employed to provide the score; and substituting the deviation by a rank of the deviation after sorting all scores to provide the discrete values.

19. The computer readable medium as recited in claim 13, wherein the first property and the second property include one of a personality trait, a user preference and a rating score.

20. The computer readable medium as recited in claim 13, wherein computing a ratio of probabilities includes computing a ratio R=P(A|B)/P(A) where P(A) is a general probability of the first property in the entire population, and P(A|B) (probability of A given B) is the probability of the first property in a sub-population where the second property also occurs.

21. The computer readable medium as recited in claim 13, wherein computing a ratio of probabilities includes computing a ratio R′=P(A|B)/P(Anot|B) where P(A|B) (probability of A given B) is the probability of the first property in a sub-population where the second property also occurs and Anot is a complementary event of the first property indicating users who do not exhibit the first property.

22. The computer readable medium as recited in claim 13, wherein reporting includes displaying the ratio of probabilities for a user.

23. The computer readable medium as recited in claim 13, wherein reporting includes alerting a third party of the probability ratio.

24. The computer readable medium as recited in claim 13, wherein the alerting is performed when the ratio of probabilities exceeds a threshold.
